(19) United States
(12) Patent Application Publication
(10) Pub. No.: US 2024/0111604 A1
(43) Pub. Date: Apr. 4, 2024

(54) CLOUD COMPUTING QOS METRIC ESTIMATION USING MODELS

(71) Applicant: Dell Products L.P., Round Rock, TX (US)

(72) Inventors: Miguel Paredes Quinones, Campinas (BR); Romulo Teixeira de Abreu Pinho, Niteroi (BR)

(21) Appl. No.: 17/933,343

(22) Filed: Sep. 19, 2022

(51) Int. Cl. G06F 9/50

(52) U.S. Cl. CPC G06F 9/5083

(57) ABSTRACT

Models to predict quality of service metrics are disclosed. A response time is predicted using an occupancy status of an infrastructure and models that have been trained to predict a response time. Estimating a metric, such as the response time, allows the infrastructure to adjust to issues such that requests better satisfy quality of service requirements.

### FIELD OF THE INVENTION

Embodiments of the present invention generally relate to cloud computing and data centers. More particularly, at least some embodiments of the invention relate to systems, hardware, software, computer-readable media, and methods for task allocation in cloud/edge computing infrastructure and to estimating quality of service in servicing client requests.

### BACKGROUND

Cloud computing is often used to create virtual environments. Virtual environments isolate or abstract the way that various operations (e.g., executing applications, performing tasks, saving data) are performed on real hardware in a data center. To manage these virtual environments, stochastic models with queuing systems are often used to estimate the expected quality of service (QoS) related to allocating tasks.

However, even assuming that servicing or allocating requests is a stochastic problem that can be modelled by some probability distribution, imposing stochasticity assumptions can lead to incorrect estimates if the assumptions are incorrect. This problem could be addressed by implicitly modeling the distributions from available request allocation telemetries. However, even assuming that a machine learning model can be trained to predict a metric for input data such as request allocation telemetries, the challenge in allocating requests is to identify which input resource usage variables are the best predictors of the metric.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an estimating engine configured to estimate a response time of client requests to a computing infrastructure;

FIG. 2 discloses aspects of a model that can be trained to estimate a response time of a load balancing engine and that, in another embodiment, can be trained to estimate a response time of a request at a physical machine;

FIG. 3 discloses aspects of discretizing a distribution of collected data associated with the response time of a load balancer into bins to prepare the collected data as a training dataset for a load balancing model;

FIG. 4 discloses aspects of training a model using a training dataset and noise;

FIG. 5 discloses aspects of discretizing a distribution of collected data associated with the response time of a physical machine into bins to prepare the collected data as a training dataset for a physical machine model;

FIG. 6 discloses aspects of data input into a generator of a physical machine model;

FIG. 7 discloses aspects of estimating a response time or other metric; and

FIG. 8 discloses aspects of a computing device, a computing system, or computing entity.

### DETAILED DESCRIPTION OF SOME EXAMPLE EMBODIMENTS

Embodiments of the present invention generally relate to cloud/edge computing and to allocating requests in cloud/edge computing environments. More particularly, at least some embodiments of the invention relate to systems, hardware, software, computer-readable media, and methods for estimating metrics, such as delay, associated with allocating requests in a computing environment.

Embodiments of the invention relate to estimating metrics related to quality of service (QoS). The time required to allocate a request or a task in a computing environment is estimated. This may include simulating the process of allocating requests and simulating parts of this process to obtain the estimated metrics. In one example, models such as Conditional Adversarial Neural Networks (also sometimes known as conditional generative adversarial networks, or cGANs) capture the underlying metric distributions and generate realistic synthetic metric values that consider the status of a computing network, such as a cloud infrastructure or portion thereof (e.g., a cluster in a datacenter).

Many services/applications available on computing devices are based on cloud data centers (CDCs). Large amounts of information/data are processed in this type of infrastructure when devices such as computers, smart phones, wearables, tablets, or the like are used. Cloud computing provides users with on demand computational resources. This is beneficial for users or other entities that do not want to own or maintain their own computing infrastructure. However, requests for using the computational resources need to be directed to the computational resource (e.g., a virtual machine).

Cloud computing may be referred or include, for example, software as a service (SaaS), Platform as a Service (PaaS), Infrastructure as a Service (IaaS), Mobile backend as a service (MBaaS), and Function as a service (FaaS).

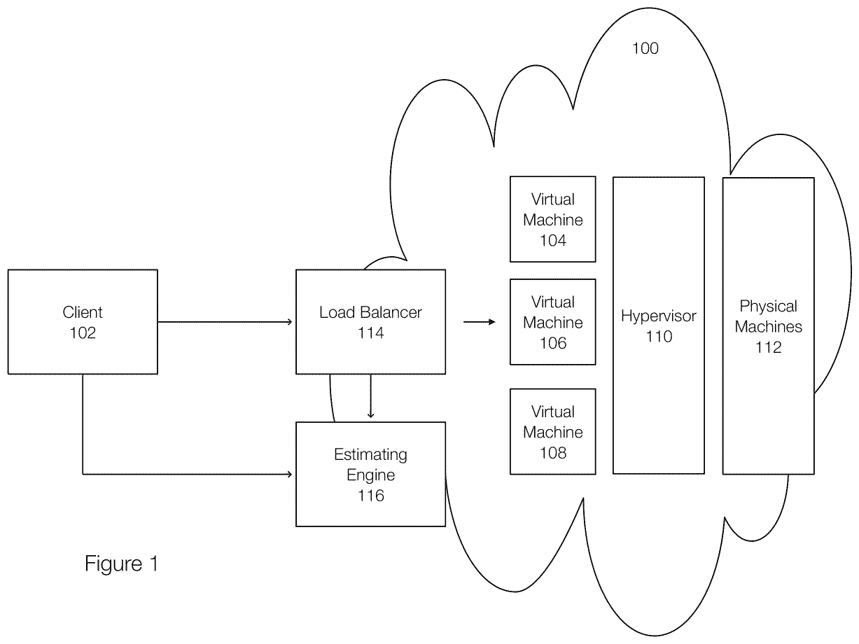

FIG. 1 discloses aspects of a computing environment in which requests are allocated or serviced. Servicing a request includes receiving the request and directing the request to computational resources configured to execute the request. The system 100 is an example of a cloud or edge computing system (or other infrastructure) that include physical machines 112. The physical machines 112 include hardware such as processors, memory, networking hardware, or the like. A provider of the system 100 may implement or run virtual machines, represented as virtual machines 104, 106, and 108, on the physical machines 112. This is often achieved using a hypervisor 110. The hypervisor 110 distributes or manages the virtual machines 104, 106, and 108 across the physical machines 112.

A hypervisor 110 can be implemented in different manners. There are, in essence, two kinds of hypervisors: the first interacts directly with the hardware and the second needs an operating system to be executed. Regardless of how the hypervisor 110 is implemented, the hypervisor 110 allocates and manages the physical machines 112 to the virtual machines running thereon. With the hypervisor 110, multiple operating systems can share the same underlying physical machines 112 with no compatibility issues. In another example, containers may be used. Containers do not need a hypervisor and may run separately in a kernel of an operating system.

Thus, the system 100 may include one or more hypervisors 110 and their associated virtual machines 104, 106, 108 or containers. The resources that the hypervisor 110 manages while scheduling the execution of virtual machines 104, 106, and 108 on the physical machines 112 includes storage, computational units, processors, network bandwidth, energy consumption, or the like or combination thereof.

Requests, such as application requests, that are managed by the system 100 are eventually executed on one the virtual machines 104, 106, and 108 or on new virtual machines that need to be launched to scale up the services provided by the system 100. Each request is processed by a scheduling step where agents (represented as the load balancer 114) assign the received requests to specific virtual machines. The load balancer 114 may be configured to distribute requests across the virtual machines or across the physical machines 112.

One QoS metric of the system 100 is the amount of time required for a request to be assigned or allocated to the destination execution environment. This may be referred to as a response time T. Embodiments of the invention relate to an estimating engine 116 configured to estimate the response time T. The estimating engine 116 may be configured to estimate the response time T for every arriving request. Embodiments of the invention are configured to reduce/optimize/estimate response times. In addition, requests can be directed or fulfilled based on the estimated response time generated by the estimating engine 116. Thus, actions can be taken in an attempt to ensure that QoS metrics are satisfied.

The load balancer 114 is configured to receive requests from clients (represented as the client 102). The load balancer 114 may have a maximum number of requests that can be processed or queued, C. The load balancer 114 is responsible for assigning a request to one of the physical machines 112 in the system 100. Requests received by the load balancer 114 may be associated with QoS metrics or requirements.

In one example, each of the physical machines 112 is associated with a set of virtual machines. Once a request is allocated to a physical machine, the request may be placed in a queue at the physical machine until processed by one of virtual machines running on the physical machine.

The load balancer 114 may include a queue that serves requests on a FIFO (First In First Out) basis. A request enters the queue if there are less than C requests in the queue, otherwise the system rejects the request. It is possible to assume the request arrivals follow some distribution process with FIFO rule, such as the Poisson process.

The response time may include two portions. The first response is associated with the load balancer 114 and a second response time is associated the physical machine that receives a request from the load balancer 114. The amount of time that a request takes to be processed by the load balancer 114 is an example of a load response time \hat{T}_{L}. As previously stated, each physical machine also has a FIFO queue. Thus, once a request is assigned from the load balancer's queue by the load balancer 114, the request waits in the physical machine's queue until assigned to one of its virtual machines. The amount of time that a request takes to be processed by the assigned physical machine is T_{D}.

The estimating engine 116 is configured to estimate the response time T of a request in the system 100. The response time T=T_{L}+T_{D} and embodiments of the invention are configured to estimate the response time T.

Example embodiments of the invention estimate the response time T by directly learning the distribution of response times in an unsupervised manner. Embodiments of the invention may also estimate T by sampling from a distribution of actual values conditioned on the occupation status of the system 100.

QoS metrics are estimated, by way of example, for cloud/edge computing environments using Conditional Generative Adversarial Networks (cGANs). Without loss of generality, the following discussion focuses on the response time T. Embodiments of the invention may be adapted for other metrics.

Generally, GANs allow a trained model to generate synthetic data that closely resembles samples from a training dataset. GANs often includes two models: a generator [symbol] and a discriminator [symbol] . The generator generates synthetic data that should resemble samples drawn from a training dataset. The discriminator, by way of example, is a binary classifier that classifies input as real or fake. During training, the generator becomes better at generating data that can fool the discriminator. The discriminator becomes progressively better at discerning between true samples drawn from the training dataset and fake or synthetic samples generated by the generator. Convergence is achieved when the discriminator is unable to differentiate between true and synthetic (fake) data. As a result, GANs implicitly learn the underlying data distribution.

cGANs also have the ability to learn distributions from some conditional prior. In one example, a tensor representation of the conditional prior is concatenated with a tensor representation of some input noise. This concatenated representation is input to the generator to generate a sample associated with the conditional prior.

For the discriminator, in one example, half of the training dataset for the discriminator is obtained with ground truth values of the data whose distribution is to be modeled along with the conditions associated therewith. The other half of the data is generated by the generator.

The tensor representation of the data samples, real or fake, is typically concatenated with the tensor representation of the conditional prior associated with it and fed to discriminator. By doing this, the discriminator not only learns to differentiate between synthetic or real data, but also learns whether the data is associated with the correct conditional prior.

Embodiments of the invention relate to models (e.g., cGAN models) configured to generate synthetic total response values \hat{T} in a data center or other infrastructure. The first model is configured to estimate the time (\hat{T}_{L}) required for a request to be assigned, by the load balancer, to a physical machine. The second model is configured to estimate the time (\hat{T}_{D}) required for a request to be executed at the physical machine (e.g., by a virtual machine operating on the physical machine). These two models each include a generator and a discriminator. These discriminators are configured to differentiate between real response times collected directly from executions of requests sent by clients and synthetic response times generated with a corresponding generator.

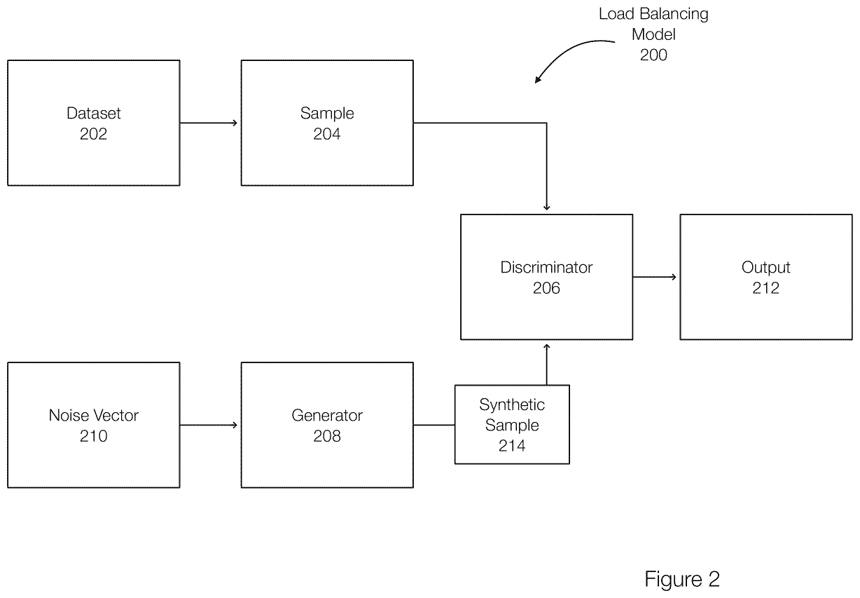

FIG. 2 discloses aspects of a model. FIG. 2 is discussed as representing a load balancing model 200. However, the model 200 also represents a physical machine model. One difference relates to the training dataset and the noise vectors.

The load balancing model 200 includes a generator 208 and a discriminator 206. The discriminator 206 is configured to differentiate between a real sample 204 from a training dataset 202 and a fake or synthetic sample 214 generated by a generator 208 that is based on a noise vector 210. In one example, the discriminator 206 receives a sample 204 and the output 212 is a probability that the sample 204 is real or fake. Similarly, the synthetic sample 214 is input to the discriminator 206, which determines a probability of whether the fake sample 214 is real or fake. In one example, the generator 208 and the discriminator 206 are configured as neural networks with, respectively, parameters θ_{L} and θ_{D}.

In one example, the load balancing response time \hat{T}_{L} may depend on conditions or the occupation status of the infrastructure that may include, for example, the number (k) of requests in the queue of the load balancer and the number (v) of virtual machines active in the infrastructure.

Embodiments of the invention may sample a value from an underlying response time distribution conditioned on the number of requests waiting in the queue k and the number of active virtual machines v.

Prior to training the load balancing model, the training dataset is prepared. This includes collecting true T_{L}, k, and v values over the execution of many client requests. This allows a dataset from which a probability distribution P(T_{L}|k, v), where {k, v} ∈ [symbol] * can be modeled.

One challenge that makes building the load balancing model difficult is that, in many consolidate implementations, the condition prior is a categorical value (e.g., a class label). However, it is difficult to represent each possible value [symbol] * as a categorical value. To overcome this challenge, embodiments of the invention collect a distribution for each of k and v (i.e., P(k), P(v)), discretize the distributions into bins using a binarization algorithm, and transform each collected value of k an v into the corresponding bin of the associated distribution.

Because the number of bins of the distributions are limited, the values in the bins can be represented as bin indices. The bin indices can be used as the conditional prior for the models. Some of the bins may be removed from the representation if the bins correspond to regions of the space with very low probability. In this example, k and v are independent variables.

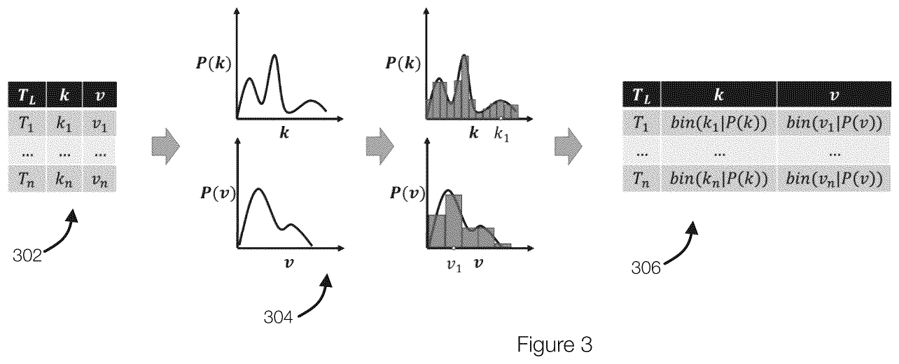

FIG. 3 discloses aspects of discretizing k and v. FIG. 3 illustrates a distribution 304 of true values 304 that have been discretized and binned. The training data samples of T_{L} 306 for each bin (T₁. . Tₙ) are illustrated. FIG. 3 thus illustrates an example of preparing a training dataset.

After collecting and transforming data, the generator model [symbol] _{L} for the load balancing model receives input that is represented as a tensor. The tensor includes a noise value z and a random pair {k,v}. This allows a concatenated tensor to be generated with z and the one hot encoded versions of bin(k|P(k)) and bin(v|P(v)). The tensor is passed through the generator and a sample \hat{T}_{L} is generated.

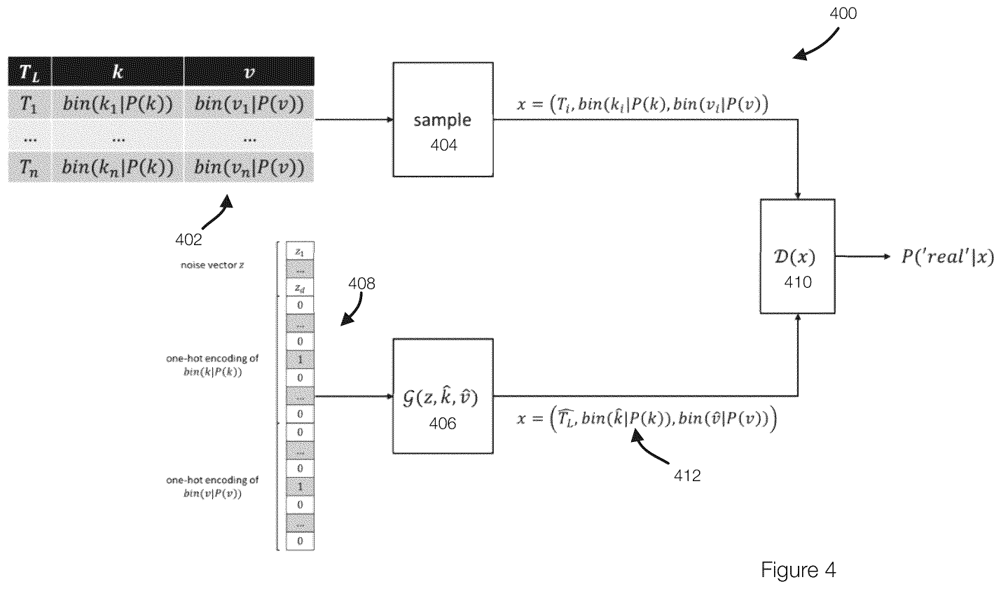

FIG. 4 discloses aspects of the load balancing model that, when trained, forms at least a portion of the estimating engine illustrated in FIG. 2. More specifically, the generator may be deployed to the estimating engine. FIG. 4 illustrates a training dataset 402 that includes true data that has been collected and transformed as illustrated in FIG. 3.

In the model 400, the tensor 408 input to the generator 406 ( [symbol] (z, \hat{k}, \hat{v})) includes a noise vector z, a one hot encoding of bin(k|P(k)) and a one hot encoding of bin(v|P(v)). The output of the generator 406 is a generated or synthesized sample 412 (x) that includes, in one example, an estimated response time \hat{T}_{L} along with values of k and v. In one example, the synthesized sample 412 x=( [symbol] bin (\hat{k}|P(k))), bin(\hat{v}|P(v))). The discriminator 410 determines whether the synthesized 412 of the generator 406 is real or fake—P(‘real’|x). Similarly, the discriminator 410 determines whether the real sample 404 from data collected in the infrastructure is x=(Tᵢ, bin(kᵢ|P(k)),bin(vᵢ|P(v)) is real.

The generator 406 and the discriminator 410 are trained at the same time with batches containing samples taken from the original data and samples generated or synthesized by the generator 406. Each of these samples are properly labeled as real or fake in one example. The loss function used for some model parameters θ [symbol] and θ [symbol] is the binary cross-entropy loss (BCE). The discriminator 410 ( [symbol] ) is trained to maximize the probability of assigning the correct label to both training examples and samples from [symbol] _{L} 406. The generator 406 or [symbol] _{L}, is trained to minimize log(1− [symbol] _{L} ( [symbol] _{L}(z|k, v)).

In this example the BCE is defined as follows:

BCE( [symbol] , [symbol] )=E_{x˜data}[log( [symbol] _{L}(x; [symbol] )]+ [symbol] (z|k,v; [symbol] )[1−log( [symbol] _{L}(x; [symbol] ))].

In this manner the load balancing model 400 is trained. Once the generator 406 is trained, the generator 406 may be used to generate estimates of the load balancing response times (T_{L}) for incoming requests. When a request arrives at the load balancer, the status of the load balancer (k) and the status of the infrastructure (v) are determined. After these values (k, v) are updated, these values are used, together with a random sample of z to assemble the conditional prior of the generator [symbol] _{L}, 406. The estimated response time output by the generator, at inference time, is [symbol] = [symbol] _{L}(z|k, v).

In addition to a load balancing model, embodiments of the invention further relate to a physical machine model. The physical machine model is configured to generate an estimated response time [symbol] for an incoming request. The physical machine model is similar to the load balancing model. One embodiment of the load balancing model relates the response time T_{D} to the number of requests k_{D} waiting at in a queue of a physical machine, the number v_{D} of virtual machines active on the physical machine, and the size s_{D} of the physical machine in terms of computing capacity. In one example, the size of the computing capacity may be categorized as small (S), medium (M), or large (L).

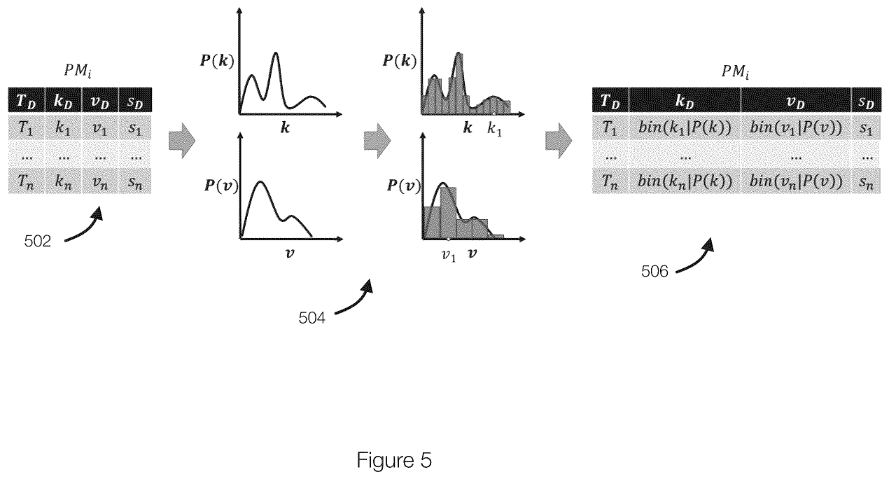

Embodiments of the invention sample a value from an underlying response time distribution conditioned on (k_{D}, v_{D}, s_{D}). FIG. 5 discloses aspects of training data related to the physical machines. FIG. 5 thus illustrates that values of (k_{D}, v_{D}, s_{D}) are collected over time for each physical machine. The training dataset, however, may aggregate all of data from all physical machines.

More specifically, the collected data 502 represents a distribution of (k_{D}, v_{D}, s_{D}) values that are discretized 504 into bins, which results in a training dataset 506.

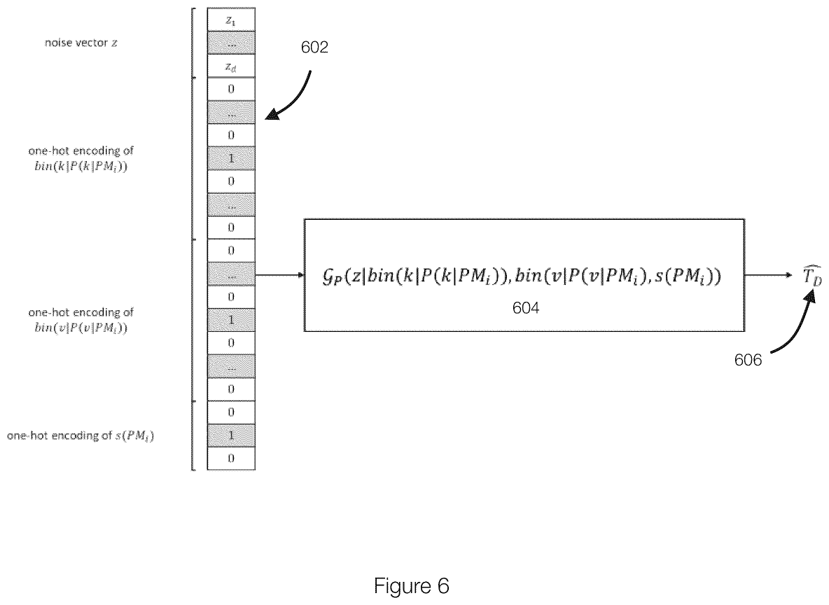

FIG. 6 discloses aspects of a physical machine learning model. The arrangement is similar to the load balancing model illustrated in FIG. 4. Differences are illustrated in FIG. 6. The physical machine model includes a generator 604 and a discriminator as described herein. In this example, the input 602 to the generator 604 includes a tensor 602. The tensor 602 is a concatenation that includes a noise vector z, a one hot encoding of bin(k|P(k|PMᵢ)), a one hot encoding of bin(v|P(v|PMᵢ)), and a one hot encoding of s(PMᵢ). The output of the generator 604 is an estimated response time 606 for the physical machine [symbol] . The discriminator of the physical machine learning model is trained, in one embodiment, until the discriminator cannot distinguish between a true sample and a synthetic sample generated by the generator 604.

When the physical machine generator is deployed and used for inferences, the physical machines in the data center (or relevant infrastructure) are probed to obtain (k_{D}, v_{D}, s_{D}) for each physical machine. This allows the response time [symbol] to be estimated by the trained generator 604. The response times may be averaged to obtain a final response time estimate [symbol] .

Thus, the estimated response time \hat{T}= [symbol] + [symbol] can be determined for each incoming request based on the current occupancy (k, v, and s).

Embodiments of the invention relate to a multiple model (e.g., a two cGAN model) that allows the quality of service of cloud infrastructure to be measured using estimates of metrics related to load balancing and request allocation. The model implicitly learns the distributions of response times using, by way of example, cGANs.

Using two models the quality of service (QoS) of cloud infra-structures to be measured through estimates of metrics related load balancing and request allocation. The model implicitly learns distributions of response times via cGANS. The cGANs are trained in such a way that the generators, once trained, can yield estimates of the desired QoS metrics conditioned on the occupation status of the cloud service or infrastructure. Although embodiments of the invention are discussed in the context of the time required to assign an incoming request to be assigned to a virtual machine and executed, embodiments of the invention can be adapted to other metrics. Advantageously, the models are unsupervised and no assumptions related to the distributions of the response times are required. More specifically, the models learn the distributions directly from the collected data.

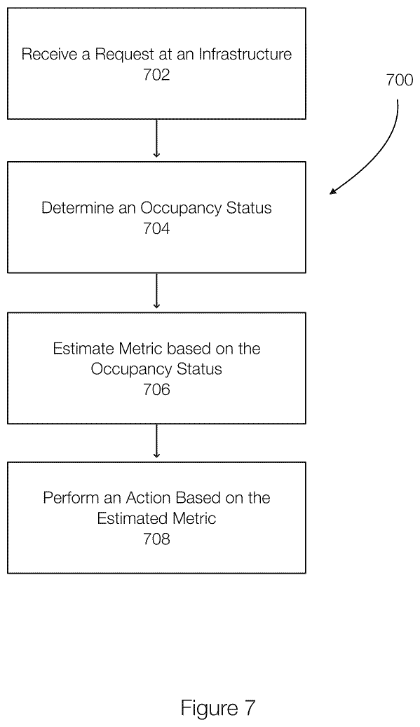

FIG. 7 discloses aspects of metric estimation. In the method 700, a request is received 702 at an infrastructure. For example, a request may be received at a load balancing engine. The load balancing engine may include an estimating engine that is configured to estimate a response time for the request. In one example, the estimating engine may include a first estimating engine and a second estimating engine. The first estimating engine may be configured to estimate the response time of the load balancer and the second estimating engine may be configured to estimate the response time at the physical machine.

In one example, the estimating engine may determine 702 an occupancy status. Because the response time includes a load balancing response time and a physical machine response time, the values for the occupancy status includes all values needed to estimate both of these response times.

Once the values are retrieved, for example, by querying the environment, a response time or other metric is estimated. This may include estimating a first metric or a load balancing metric based on at least the occupancy values of number of requests in the load balancing queue and number of active virtual machines. A second metric or physical machine metric may also be estimated based on at least the occupancy values of a number of requests in the physical machine queue, number of virtual machines running on a physical machine, and a size of the machine. In one example, the physical machine metric is estimated for each physical machine and the estimated physical machine response time may be an average of the individual estimated response times.

Once the metric or response time is estimated, an action 708 may be performed if the metric is below a quality of service requirement (e.g., a quality of service value) or service level agreement requirement, which suggest that the quality of service is insufficient.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general, however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a request at an infrastructure, determining an occupancy status of a load balancing engine and an occupancy status of physical machines in the infrastructure, estimating a first metric based on the occupancy status of the load balancing engine and a first noise vector with a first estimating engine, estimating a second metric based on the occupancy status of the physical machines and a second noise vector with a second estimating engine, determining an estimated total metric from the first metric and the second metric, and performing an action when the estimated total metric is below a quality of service value.

Embodiment 2. The method of embodiment 1, wherein the first metric relates to a response time measured from receiving the request to assigning the request to a physical machine, wherein the request is moved from a queue of the load balancing engine to a queue of the physical machine.

Embodiment 3. The method of embodiment 1 and/or 2, wherein the second metric relates to a response time measured from receiving the request at the physical machine to assigning the request to a virtual machine operating on the physical machine or to sending a response to the request.

Embodiment 4. The method of embodiment 1, 2, and/or 3, wherein the first metric relates to a response time of the load balancing engine and the second metric relates to a response time of the physical machines.

Embodiment 5. The method of embodiment 1, 2, 3, and/or 4, wherein the estimating engine comprises a load balancing generator and a physical machine generator, further comprising estimating the response time of the load balancing engine using the load balancing generator that has been trained in a load balancing model and estimating the response time of the physical machines using the physical machine generator that has been trained in a physical machine model.

Embodiment 6. The method of embodiment 1, 2, 3, 4, and/or 5, wherein the load balancing model implicitly learns a distribution of real response times associated with occupancy values associated with the load balancing engine, the occupancy values including a number of requests in a load balancing queue and a number of active virtual machines in the infrastructure.

Embodiment 7. The method of embodiment 1, 2, 3, 4, 5, and/or 6, wherein the physical machine model implicitly learns a distribution of real response times associated with occupancy values associated with the physical machines the occupancy values including a number of requests in a load balancing queue, a number of active virtual machines in the infrastructure, and size of each physical machine.

Embodiment 8. The method of embodiment 1, 2, 3, 4, 5, 6, and/or 7, wherein an input to the load balancing generator comprises a tensor including a noise vector, a one hot coding related to the number of requests in a load balancing queue and the number of active virtual machines, wherein an input to the physical machine vector comprises a tensor including a noise vector, a one hot encoding related to the number of requests in a physical machine queue, the number of active virtual machines on a physical machine, and the size of the physical machine.

Embodiment 9. The method of embodiment 1, 2, 3, 4, 5, 6, 7, and/or 8, wherein the load balancing model comprises a load balancing discriminator configured to determine whether an input to the load balancing discriminator is real or fake and wherein the physical machine model comprises a physical machine discriminator configured to determine whether an input to the physical machine discriminator is real or fake.

Embodiment 10. The method of embodiment 1, 2, 3, 4, 5, 6, 7, 8, and/or 9, further comprising training the load balancing model and the physical machine model using ground truth data that is discretized and binned.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or Docket No: 16192.660 processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

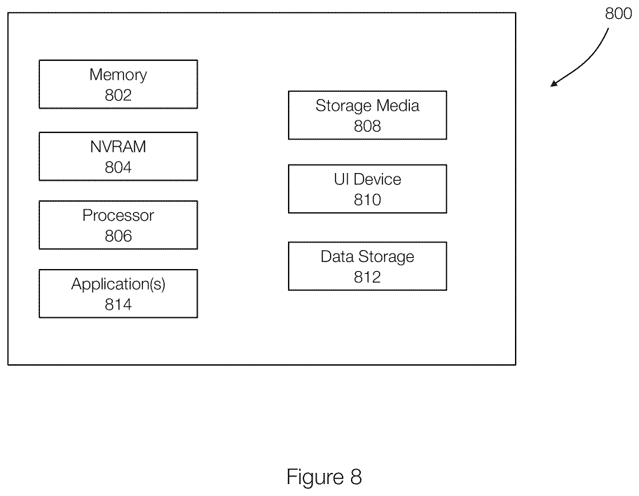

With reference briefly now to FIG. 8, any one or more of the entities disclosed, or implied, by the Figures, and/or elsewhere herein, may take the form of, or include, or be implemented on, or hosted by, a physical computing device, one example of which is denoted at 800. As well, where any of the aforementioned elements comprise or consist of a virtual machine (VM) (or container), that VM may constitute a virtualization of any combination of the physical components disclosed in FIG. 8. The device 800 may also represent a plurality of devices, such as a cluster, or other infrastructure including a datacenter.

In the example of FIG. 8, the physical computing device 800 includes a memory 802 which may include one, some, or all, of random-access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid-state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a request at an infrastructure;
determining an occupancy status of a load balancing engine and an occupancy status of physical machines in the infrastructure;
estimating a first metric based on the occupancy status of the load balancing engine and a first noise vector with a first estimating engine;
estimating a second metric based on the occupancy status of the physical machines and a second noise vector with a second estimating engine;
determining an estimated total metric from the first metric and the second metric; and
performing an action when the estimated total metric is below a quality of service value.

2. The method of claim 1, wherein the first metric relates to a response time measured from receiving the request to assigning the request to a physical machine, wherein the request is moved from a queue of the load balancing engine to a queue of the physical machine.

3. The method of claim 1, further comprising wherein the second metric relates to a response time measured from receiving the request at the physical machine to assigning the request to a virtual machine operating on the physical machine or to sending a response to the request.

4. The method of claim 1, wherein the first metric relates to a response time of the load balancing engine and the second metric relates to a response time of the physical machines.

5. The method of claim 4, wherein the estimating engine comprises a load balancing generator and a physical machine generator, further comprising estimating the response time of the load balancing engine using the load balancing generator that has been trained in a load balancing model and estimating the response time of the physical machines using the physical machine generator that has been trained in a physical machine model.

6. The method of claim 5, wherein the load balancing model implicitly learns a distribution of real response times associated with occupancy values associated with the load balancing engine, the occupancy values including a number of requests in a load balancing queue and a number of active virtual machines in the infrastructure.

7. The method of claim 5, wherein the physical machine model implicitly learns a distribution of real response times associated with occupancy values associated with the physical machines, the occupancy values including a number of requests in a load balancing queue, a number of active virtual machines in the infrastructure, and size of each physical machine.

8. The method of claim 5, wherein an input to the load balancing generator comprises a tensor including a noise vector, a one hot coding related to the number of requests in a load balancing queue and the number of active virtual machines, wherein an input to the physical machine vector comprises a tensor including a noise vector, a one hot encoding related to the number of requests in a physical machine queue, the number of active virtual machines on a physical machine, and the size of the physical machine.

9. The method of claim 8, wherein the load balancing model comprises a load balancing discriminator configured to determine whether an input to the load balancing discriminator is real or fake and wherein the physical machine model comprises a physical machine discriminator configured to determine whether an input to the physical machine discriminator is real or fake.

10. The method of claim 9, further comprising training the load balancing model and the physical machine model using ground truth data that is discretized and binned.

11. A non-transitory storage medium having stored therein instructions that are executable by one or more hardware processors to perform operations comprising:
receiving a request at an infrastructure;
determining an occupancy status of a load balancing engine and an occupancy status of physical machines in the infrastructure;
estimating a first metric based on the occupancy status of the load balancing engine and a first noise vector with a first estimating engine;
estimating a second metric based on the occupancy status of the physical machines and a second noise vector with a second estimating engine;
determining an estimated total metric from the first metric and the second metric; and
performing an action when the estimated total metric is below a quality of service value.

12. The non-transitory storage medium of claim 11, wherein the first metric relates to a response time measured from receiving the request to assigning the request to a physical machine, wherein the request is moved from a queue of the load balancing engine to a queue of the physical machine.

13. The non-transitory storage medium of claim 11, wherein the second metric relates to a response time measured from receiving the request at the physical machine to assigning the request to a virtual machine operating on the physical machine or to sending a response to the request.

14. The non-transitory storage medium of claim 11, wherein the first metric relates to a response time of the load balancing engine and the second metric relates to a response time of the physical machines.

15. The non-transitory storage medium of claim 14, wherein the estimating engine comprises a load balancing generator and a physical machine generator, further comprising estimating the response time of the load balancing engine using the load balancing generator that has been trained in a load balancing model and estimating the response time of the physical machines using the physical machine generator that has been trained in a physical machine model.

16. The non-transitory storage medium of claim 15, wherein the load balancing model implicitly learns a distribution of real response times associated with occupancy values associated with the load balancing engine, the occupancy values including a number of requests in a load balancing queue and a number of active virtual machines in the infrastructure.

17. The non-transitory storage medium of claim 15, wherein the physical machine model implicitly learns a distribution of real response times associated with occupancy values associated with the physical machines the occupancy values including a number of requests in a load balancing queue, a number of active virtual machines in the infrastructure, and size of each physical machine.

18. The non-transitory storage medium of claim 15, wherein an input to the load balancing generator comprises a tensor including a noise vector, a one hot coding related to the number of requests in a load balancing queue and the number of active virtual machines, wherein an input to the physical machine vector comprises a tensor including a noise vector, a one hot encoding related to the number of requests in a physical machine queue, the number of active virtual machines on a physical machine, and the size of the physical machine.

19. The non-transitory storage medium of claim 18, wherein the load balancing model comprises a load balancing discriminator configured to determine whether an input to the load balancing discriminator is real or fake and wherein the physical machine model comprises a physical machine discriminator configured to determine whether an input to the physical machine discriminator is real or fake.

20. The non-transitory storage medium of claim 19, further comprising training the load balancing model and the physical machine model using ground truth data that is discretized and binned.
